(19) United States
(12) Patent Application Publication
(10) Pub. No.: US 2006/0204017 A1
(43) Pub. Date: Sep. 14, 2006

(54) Audio/video system for wireless driving of loudspeakers

(75) Inventor: Paul Ullmann, Vienna (AT)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA Eindhoven (NL)

(21) Appl. No.: 10/568,642

(22) PCT Filed: Aug. 19, 2004
(86) PCT No.: PCT/IB04/51494

§ 371 Date: Feb. 16, 2006

(30) Foreign Application Priority Data
Aug. 22, 2003 (EP) 03103216.2

(51) Int. Cl. H04B 5/00; H04B 3/00

(52) U.S. Cl. 381/79; 381/77

(57) ABSTRACT

In an audio/video system (AV) with distributed loudspeakers and an audio/video playback unit (CU) for the reproduction of audio signals from audio channels over the respective loudspeakers, the audio/video playback unit (CU) is designed for transforming the audio signals (ARL, ARR) of at least one audio channel into modulated ultrasonic signals (URLR) and for transmitting the modulated ultrasonic signals together with the audio signals (AFL, AFR) of an audio channel via at least one transmitting loudspeaker (FL, FR) connected to the audio/video playback unit (CU) to at least one receiving loudspeaker (RL, RR) that is not connected to the audio/video playback unit. The receiving loudspeaker has an inverse transforming device (8) for inverse transformation of the received modulated ultrasonic signals (URLR) into inverse-transformed audio signals (ARL, ARR) and for acoustic radiation of the inverse-transformed audio signals.

The invention relates to an audio/video system with distributed loudspeakers and an audio/video playback unit for the reproduction of audio signals of audio channels over the respective loudspeakers.

The invention further relates to an audio/video playback unit for the reproduction of audio signals from audio channels.

The invention further relates to a transmitting loudspeaker.

The invention further relates to a receiving loudspeaker.

The terms “audio/video system” and “audio/video playback unit” are to be understood in the present case as meaning that it can relate both to an audio system (also called a “sound system”) or a playback unit for the reproduction of only audio signals and to a system or a playback unit for the reproduction of audio signals and video signals.

An audio/video system of this kind and an audio/video playback unit of this kind are known from document WO 98/59525. This document discloses a sound system for producing a surround-sound effect with headphones, said headphones providing the user of the headphones with directional hearing that is dependent on head position. In addition to two-channel audio signals, an ultrasonic reference signal is sent to the headphones worn by the user. The microphones fitted to the headphones on the left and right receive the ultrasonic reference signal. A phase difference of the ultrasonic reference signal is determined from the times of arrival of the ultrasonic reference signal at each of these microphones, and it can be concluded from said phase difference at what angle to a central axis the user's head is turned. The audio signals sent to the headphones are modulated in relation to the phase difference determined. The audio signals are transmitted to the headphones by means of a modulated ultrasonic signal from a special, separate ultrasonic transmitting device, which is coupled to the audio/video playback unit.

A disadvantage found with the known audio/video system is that a separate ultrasonic transmitting device is required for its operation. This not only increases the price of the audio/video system, but also stops many users buying such a system at all because the ultrasonic transmitting device must be set up in a living-room as an additional piece of equipment and has to be wired up to the audio/video playback unit. Because ultrasonic transmitters are highly directional, usually it is also necessary to set up the ultrasonic transmitting device with a line of sight to the location where the headphones will normally be used, and this is often undesirable on aesthetic grounds.

The problem to be solved by the invention is to create an audio/video system according to the type stated in the first paragraph above, an audio/video playback unit according to the type stated in the second paragraph above, a transmitting loudspeaker according to the type stated in the third paragraph above and a receiving loudspeaker according to the type stated in the fourth paragraph above, in which the aforementioned disadvantages are avoided. To solve the aforementioned problem, in an audio/video system according to the invention, features according to the invention are provided, so that an audio/video system according to the invention can be characterized as follows:

Audio/video system with distributed loudspeakers and an audio/video playback unit for the reproduction of audio signals from audio channels over the respective loudspeakers and with transforming means for transforming the audio signals of at least one audio channel into modulated ultrasonic signals and with transmitting means for transmitting the modulated ultrasonic signals together with the audio signals of an audio channel to at least one transmitting loudspeaker, said transmitting loudspeaker being designed for emitting the modulated ultrasonic signals together with the audio signals of an audio channel, and with a receiving loudspeaker, said receiving loudspeaker being provided with inverse transforming means for inverse transforming of received modulated ultrasonic signals into inverse-transformed audio signals and for emitting the inverse-transformed audio signals to at least one loudspeaker of the audio/video system that is not connected to the audio/video playback unit.

To solve the aforementioned problem, an audio/video playback unit according to the invention is provided with features according to the invention, so that an audio/video playback unit according to the invention can be characterized as follows:

Audio/video playback unit for the reproduction of audio signals from audio channels with transforming means, said transforming means being designed for transforming the audio signals of at least one audio channel into modulated ultrasonic signals, and with transmitting means for transmitting the modulated ultrasonic signals together with the audio signals of an audio channel to at least one transmitting loudspeaker, said transmitting loudspeaker being designed for emitting the modulated ultrasonic signals together with the audio signals of an audio channel.

To solve the aforementioned problem, a transmitting loudspeaker according to the invention is provided with features according to the invention, so that a transmitting loudspeaker according to the invention can be characterized as follows:

Transmitting loudspeaker with signal receiving means for the reception of audio signals and modulated ultrasonic signals and with emitting means for emitting the audio signals and the ultrasonic signals.

To solve the aforementioned problem, a receiving loudspeaker according to the invention is provided with features according to the invention, so that a receiving loudspeaker according to the invention can be characterized as follows:

Receiving loudspeaker with receiving means for the reception of modulated ultrasonic signals and with demodulating means provided as inverse transforming means for the demodulating of audio signals contained in the ultrasonic signals and with reproducing means for the acoustic reproduction of the audio signals.

The features according to the invention give a considerable reduction of costs, because it is possible to utilize elements of an audio/video system that are present anyway. In other words, there are no or only negligible additional material costs for providing the expansion of function, according to the invention, of an audio/video system such as described. Since the signal transmission of at least one audio channel is wireless, a reduction in the cost of wiring is achieved. This reduction in the cost of wiring is notable for two reasons. Firstly, in residential premises it is often difficult to lay cables in such a way that they do not get in the way and are also visually unobtrusive. Secondly it has been found that cables are a main factor in malfunctions of audio/video systems. Accordingly, a reduction in wiring by each individual cable increases the operational reliability of the audio/video system appreciably.

In an audio/video system according to the invention, the transforming means for transforming the audio signals of at least one audio channel into modulated ultrasonic signals can be contained in the transmitting loudspeaker. However, it has proved especially advantageous if the measures according to claim 2 or claim 7 are provided. This is advantageous in particular with respect to simple system design.

According to the measures of claims 3 and 4, the advantage is obtained that a loudspeaker can be used for combined transmission of several audio channels, transmitting the acoustic signals of one audio channel and at the same time the signals of other audio channels transformed to the ultrasonic range. This is advantageous with respect to lowest possible material costs of an audio/video system or an audio/video playback unit according to the invention.

According to the measures of claim 8, the problems of setting up individual, but especially the back loudspeakers, connected with surround audio/video systems, are solved.

According to the measures of claim 10, processing of the audio signals and their transformation to the ultrasonic range can be executed by software, and therefore flexibly and inexpensively.

According to the measures of claims 11 and 12, the required transmission bandwidth in the ultrasonic range is reduced, so that lower frequency response requirements can be imposed on the transmitting loudspeaker.

According to the measures of claim 13, higher selectivity of the individual audio channels is achieved.

According to the measures of claims 15 and 16, it is possible to use commercially available loudspeaker boxes, which is advantageous for keeping material costs as low as possible. The loudspeaker boxes can if necessary be supplemented with an ultrasonic tweeter.

According to the measures of claim 18, it is possible, advantageously, for a user to choose which audio channel should be reproduced.

According to the measures of claim 19, an inexpensive, efficient and flexible receiving loudspeaker is obtained.

These and other aspects of the invention are apparent from and will be elucidated with reference to the embodiments described hereinafter.

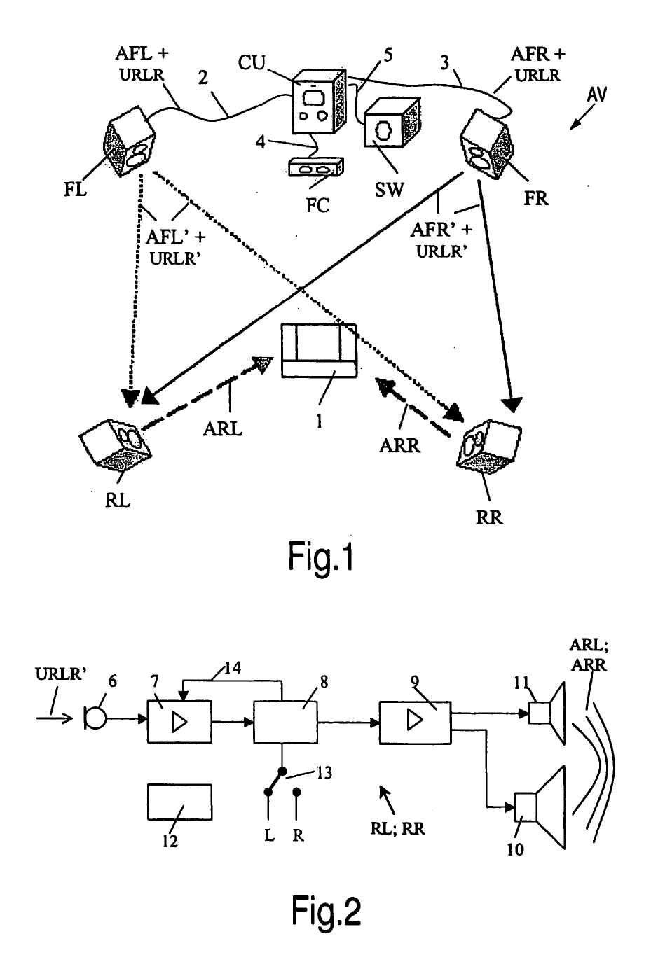

FIG. 1 shows schematically a 5.1-multichannel audio/video system according to one embodiment of the invention.

FIG. 2 shows, as a block diagram, a receiving loudspeaker according to one embodiment of the invention.

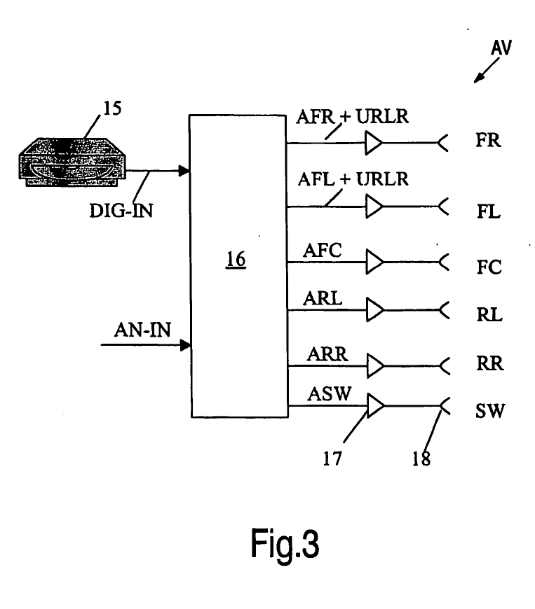

FIG. 3 shows, as a block diagram, an audio/video playback unit according to one embodiment of the invention.

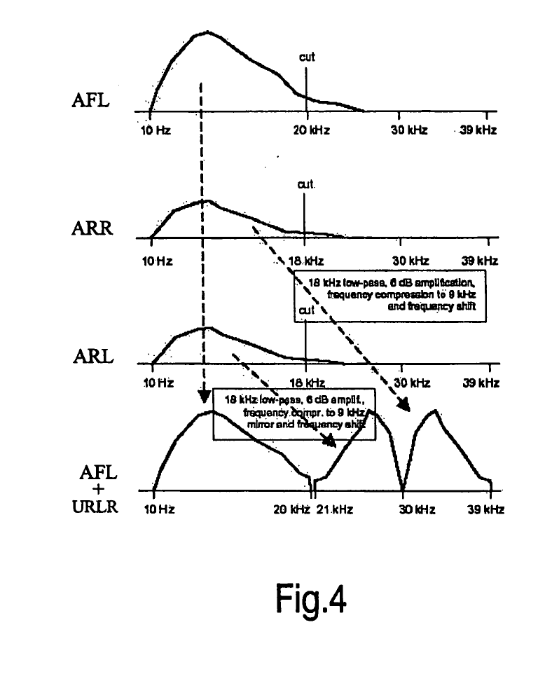

FIG. 4 shows a level-frequency diagram with respect to the transformation of audio signals into modulated ultrasonic signals.

FIG. 1 shows schematically an audio/video system AV according to the invention, which is designed as a surround audio/video system in accordance with the 5.1 multichannel standard. 5.1 multichannel standard means that the following audio channels are present: front-left, front-center, front-right, back-left, back-right and a subwoofer channel for transmitting very low-frequency sounds, which the human ear can hear but is unable to locate, so that no location is assigned to them in this surround system. The present audio/video system AV comprises an audio/video playback unit CU, which is called the Central Unit in technical circles and contains means, not shown in more detail, for the playback of data stored on DVDs or CDs or audio or audio/video data stored on magnetic, magneto-optical or memory-IC based storage media or data transmitted over a network. DVDs have the property, among other things, that they can store a large number of audio channels, said audio channels being reproduced from the DVD as a so-called digital bitstream. The audio/video playback unit CU processes the bitstream, whereby the audio signals of the individual audio channels are extracted from it, manipulated (e.g. by raising or lowering certain frequency ranges) and amplified. The amplified audio signals of all audio channels are fed to an edge connector at the back of the audio/video playback unit CU, where they are conveyed by loudspeaker cables to loudspeakers or loudspeaker boxes, to feed these loudspeakers and radiate the audio signals as audible sound. According to the 5.1 multichannel standard, the following loudspeakers are envisaged, which are assigned to the above-mentioned audio channels: loudspeaker FL (front-left), central loudspeaker FC (front-center), loudspeaker FR (front-right), back-left loudspeaker RL (back-left), back-right loudspeaker RR (back-right) and a bass loudspeaker box SW (subwoofer). Generally the front left and right loudspeakers FL, FR are the qualitatively highest of the distributed loudspeaker system, i.e. those with the largest frequency response and the lowest distortion, as the major portion of music is radiated by these loudspeakers and they are also mainly responsible for directional hearing. The central loudspeakers FC are mainly for reproducing speech in films, so that their frequency response need not cover the entire audible range, but can be restricted to below 10 kHz. Quality requirements are generally lower for the rear loudspeakers RL, RR, because on the one hand they mainly transmit background sounds, the level of which is mostly low in comparison with the total sound energy transmitted. In the illustration in FIG. 1 the optimum hearing position is represented by a sofa 1, and from said sofa 1 a user of the audio/video system can assume a hearing position. In the present case the audio/video playback unit CU is connected via a first loudspeaker cable 2 to the front-left loudspeaker FL, via a second loudspeaker cable 3 to the front-right loudspeaker FR, via a third loudspeaker cable 4 to the central loudspeaker FC and via a fourth loudspeaker cable 5 to the bass loudspeaker box SW. High-grade loudspeaker cables consist of thick copper strands and therefore the problem of expensive wiring associated with surround audio/video systems is obvious. Although it is still relatively easy to wire up the audio/video playback unit to the front loudspeakers, which are generally positioned near the audio/video playback unit, this is more difficult for the rear loudspeakers, as the wiring must in this case run across the room or along the walls of the room. The latter, in particular, requires appreciable lengths of cable.

To reduce this cost of wiring, according to the invention the audio signals of at least one audio channel are sent by wireless transmission to one or more respective loudspeakers, the fundamental idea of the invention being based on transmitting these audio signals ultrasonically to the respective loudspeaker(s). In the present embodiment, the audio signals of at least one audio channel are transformed into modulated ultrasonic signals in the audio/video playback unit CU. These modulated ultrasonic signals are transmitted, together with the audio signals of an audio channel via at least one loudspeaker, connected by cable to the audio/video playback unit, which the at least one loudspeaker operates as a transmitting loudspeaker, to at least one loudspeaker of the surround audio/video system, which is not connected to the audio/video playback unit but serves as a receiving loudspeaker. The receiving loudspeaker is equipped with inverse transforming means for inverse transformation of the received modulated ultrasonic signals into inverse-transformed audio signals and has in addition reproducing means, said reproducing means being formed by a loudspeaker, in order to radiate the inverse-transformed audio signals. In the present case the audio signals ARL and ARR, i.e. the audio signals of the back-left audio channel and of the back-right audio channel, are converted to modulated ultrasonic signals URLR, said modulated ultrasonic signals URLR are mixed with the audio signals AFL of the front-left audio channel and are transmitted via the first loudspeaker cable 2, which serves here as transmitting means, to the loudspeaker FL. The loudspeaker FL is in the form of a passive loudspeaker box and emits, as a transmitting loudspeaker, a sound signal AFL′ and an ultrasonic signal URLR′. Loudspeaker FL comprises a frequency-separating filter, which separating filter distributes the incoming signal AFL+URLR from the audio/video playback unit CU between bass loudspeaker and treble loudspeaker according to high and low frequency components. If required, the frequency spectrum can be divided into more than two channels and/or distributed to more than one loudspeaker (driver) per channel. An important point is that the treble loudspeaker is also capable of transmitting the ultrasonic signals URLR′. This requirement is, however, already fulfilled by many commercially available loudspeaker boxes, whose frequency range goes beyond the audible range of max. 20 kHz. Many loudspeaker boxes are for example capable of transmitting sound up to 40 kHz and can therefore be used for the present purposes. As an alternative, loudspeaker boxes can be equipped with an ultrasonic tweeter, so as to be able to transmit the required ultrasonic frequency range.

Although basically it is sufficient for an audio signal that has been transformed into the ultrasonic range to be radiated over just one loudspeaker or loudspeaker box, the present embodiment envisages mixing the modulated ultrasonic signals URLR of the back-left audio channel and of the back-right audio channel at the same time with the audio signals AFR of the front-right channel and radiating them via the loudspeaker box FR. This avoids the highly directional ultrasonic signal URLR′ being shaded by items of furniture or the like. For example, the sofa 1 might shade the receiving loudspeaker RR from receiving the ultrasonic signal URLR′ radiated by the front-left loudspeaker box FL.

The transformed ultrasonic signal URLR′ of the audio signals ARL and ARR, radiated by loudspeaker boxes FL or FR, arrives at the back loudspeakers RL and RR. Both loudspeakers RL and RR are designed as receiving loudspeakers, i.e. they possess—as shown in FIG. 2—receiving means for receiving ultrasonic signals, here in the form of the microphone 6 for receiving the ultrasonic signal URLR′, the output signals of which are amplified by a microphone amplifier 7 and are fed to a digital signal processor 8 as the received ultrasonic signal URLR. The digital signal processor 8 serves as demodulating means for demodulating the audio signals ARL and ARR contained in the received ultrasonic signal URLR. Since the audio signals ARL and ARR in the present example are jointly transformed into a modulated ultrasonic signal URLR, a selector switch 13 is provided on the receiving loudspeakers RL, RR, for selecting either the back-left or the back-right channel. Depending on the position of the selector switch 13, the digital signal processor 8 supplies either the demodulated back-left or demodulated back-right audio signal (ARL; ARR) to an amplifier 9, said amplifier 9 feeding a bass loudspeaker 10 and a treble loudspeaker 11 either directly and independently of one another (“bi-amplifying”) or jointly via a passive frequency-separating filter (not shown). The receiving loudspeaker RL, RR is in the form of an active loudspeaker box, i.e. a power supply unit 12 is provided for supplying power to the electrical components described. Furthermore, the digital signal processor 8 has feedback via line 14 to the microphone amplifier 7 for automatic adjustment of the amplification factor of the microphone amplifier 7. As an alternative to the digital signal processor 8, an electronic circuit could be used as the demodulating means, incorporating a phase-locked-loop (PLL) circuit for demodulating the ultrasonic signals URLR.

FIG. 3 shows a block diagram of the audio/video playback unit CU according to the invention, of the multichannel audio/video system AV in FIG. 1. A DVD player 15 supplies a digital audio stream DIG-IN, in which the audio signals AFL, AFR, AFC, ARL, ARR, ASW of the audio channels described above are encoded. These audio signals are decoded from the audio stream DIG-IN by a digital signal processor 16. In addition the digital signal processor 16 has inputs for analog audio signals AN-IN of several channels, one of which is shown in the drawing. The digital signal processor 16 is designed as a modulating means for modulating the audio signals of at least one audio channel into modulated ultrasonic signals and for transmitting the modulated ultrasonic signals over at least one audio channel together with the audio signals of this audio channel. More precisely, the audio signals ARL and ARR are transformed jointly into the ultrasonic frequency range, i.e. converted to a modulated ultrasonic signal URLR, which ultrasonic signal URLR is mixed on the one hand with the audio signal AFL of the front-left channel and on the other hand with the audio signal AFR of the front-right channel and is transmitted over both channels. Each audio channel is fed by the digital signal processor 16 to a respective channel amplifier 17, said channel amplifier 17 amplifies the audio signal supplied to it (and if applicable the mixed ultrasonic signal) and supplies it to a connecting socket 18, said connecting socket 18 being designed for connecting to a loudspeaker. It should be noted that the audio signals ARL and ARR are not only emitted as transformed ultrasonic signals over the front-left and front-right audio channel, but in addition the corresponding audio signals ARL and ARR are supplied to the loudspeaker sockets for the back-left and back-right audio channel, so that the user is free to choose whether to connect the loudspeakers RL and RR via loudspeaker cables or to use wireless connection via the ultrasonic link to the audio/video playback unit CU.

It should be mentioned that the user can select which channels are transformed into the ultrasonic range and over which audio channels the transformed ultrasonic signal is transmitted.

It should further be mentioned that the audio signals of one channel can be transformed into the ultrasonic range and can be transmitted over this audio channel together with the original audio signal of this channel or instead of the original audio signal. When transmitting only the ultrasonic signals it would be sufficient to attach a loudspeaker to the corresponding audio-channel connecting socket that only operates in the ultrasonic frequency range, e.g. an ultrasonic tweeter.

FIG. 4 shows a level-frequency diagram, which shows an embodiment whereby the digital signal processor 16 of FIG. 3 can execute the transformation of audio signals into modulated ultrasonic signals. An instantaneous value of the original audio signal AFL of the front-left audio channel in the frequency domain is shown in the top row of the level-frequency diagram. It can be seen that the frequency band of the audio signal AFL extends somewhat above the audible range of 20 kHz. As these frequency components above 20 kHz do not make a notable contribution to the overall sound, to reduce the required transmission bandwidth they are cut off at 20 kHz by a low-pass filter.

An instantaneous value of the original audio signal ARR of the back-right audio channel in the frequency domain is shown in the second row of the level-frequency diagram. The frequency components of this audio signal ARR extend somewhat above 18 kHz. An instantaneous value of the original audio signal ARL of the back-left audio channel in the frequency domain is shown in the third row of the level-frequency diagram. The frequency components of this audio signal ARR also extent somewhat above 18 kHz.

The audio signals ARL and ARR are now prepared for transmission, by being passed through a low-pass filter with a cut-off frequency of 18 kHz. As mainly background sounds are transmitted via the rear channels in a multichannel audio/video system, cutting off these signals at 18 kHz does not cause any significant sound loss. Next the two signals ARL and ARR are amplified by six (6) dB and their frequency band is compressed to a half, i.e. 9 kHz. Then the audio signal ARR thus prepared is displaced into the ultrasonic frequency range between 30 kHz and 39 kHz and is mixed with the filtered audio signal AFL, which assumes a bandwidth between 0 and 20 kHz. The compressed audio signal ARL is reflected again, displaced into the frequency range between 21 kHz and 30 kHz and superimposed on the other two signals, giving one signal that is made up of the audio signal AFL and the modulated ultrasonic signal URLR. The mixed signal AFL+URLR is shown in the bottom row of the level-frequency diagram. Mirroring the signal ARL leads to better signal separation from the signal AFR. This mixed signal AFL+URLR is now radiated via a transmitting loudspeaker to a receiving loudspeaker, and in said receiving loudspeaker the ultrasonic component is demodulated back to the audio signals ARL and ARR in steps that are the reverse of the modulation procedure described. Which of the audio signals ARL and ARR is then actually radiated acoustically from the receiving loudspeaker depends on the position of the selector switch, as described above with reference to FIG. 2.

1. An audio/video system (AV) with distributed loudspeakers and an audio/video playback unit (CU) for the reproduction of audio signals (AFL, AFR, ARL, ARR) from audio channels via the respective loudspeakers and with transforming means (16) for transforming the audio signals (ARL, ARR) of at least one audio channel into modulated ultrasonic signals (URLR) and with transmitting means for transmitting the modulated ultrasonic signals (URLR) together with the audio signals (AFL, AFR) of an audio channel to at least one transmitting loudspeaker, said transmitting loudspeaker being designed for emitting the modulated ultrasonic signals (URLR) together with the audio signals (AFL, AFR) of an audio channel, and with a receiving loudspeaker (RL, RR), said receiving loudspeaker being provided with inverse transforming means (6, 7, 8) for the inverse transformation of the received modulated ultrasonic signals (URLR) into inverse-transformed audio signals (ARL, ARR) and for emitting the inverse-transformed audio signals to at least one loudspeaker of the audio/video system that is not connected to the audio/video playback unit.

2. An audio/video system (AV) according to claim 1, wherein the transforming means (16) are contained in the audio/video playback unit (CU).

3. An audio/video system (AV) according to claim 1, wherein the transmitting loudspeaker is in the form of a loudspeaker box, said loudspeaker box being designed for emitting an ultrasonic signal (URLR) representing a single or several audio channels, together with the audio signals (AFL, AFR) of one or more other audio channels.

4. An audio/video system (AV) according to claim 3, wherein the modulated ultrasonic signals (URLR) can be transmitted together with the audio signals (AFL, AFR) of at least one audio channel via an electrical connection directly to the at least one transmitting loudspeaker.

5. An audio/video system (AV) according to claim 1, wherein the audio/video system (AV) is in the form of a surround audio/video system with front loudspeaker boxes (FL, FC, FR) and back loudspeaker boxes (RL, RR) and an optional subwoofer (SW).

6. An audio/video playback unit (CU) for the reproduction of audio signals from audio channels with transforming means (16), said transforming means (16) being designed for transforming the audio signals (ARL, ARR) of at least one audio channel into modulated ultrasonic signals (URLR), and with transmitting means for transmitting the modulated ultrasonic signals (URLR) together with the audio signals (AFL, AFR) of an audio channel to at least one transmitting loudspeaker, said transmitting loudspeaker being designed for emitting the modulated ultrasonic signals (URLR) together with the audio signals (AFL, AFR) of an audio channel.

7. An audio/video playback unit (CU) according to claim 6, wherein the transforming means (16) comprise modulating means for modulating the audio signals of at least one audio channel into modulated ultrasonic signals (URLR) and the modulated ultrasonic signals (URLR) can be transmitted over at least one audio channel together with the audio signals of this audio channel.

8. An audio/video playback unit (CU) according to claim 6 for the reproduction of audio signals from at least two audio channels, wherein the modulated ultrasonic signals (URLR) produced by the transforming means (16) from the audio signals of at least one audio channel can be transmitted over at least one other audio channel together with the audio signals (AFL, AFR) of this other audio channel.

9. An audio/video playback unit (CU) according to claim 6, wherein the audio/video playback unit (CU) is designed for the processing of digital (DIG-IN) and/or analog (AN-IN) audio streams.

10. An audio/video playback unit (CU) according to claim 6, wherein the transforming means (16) are in the form of a digital signal processor.

11. An audio/video playback unit (CU) according to claim 6, wherein the transforming means (16) contain a low-pass filter, in order to filter out frequency components over 20 kHz, preferably over 18 kHz, from the audio signals that are to be transformed into the ultrasonic frequency range.

12. An audio/video playback unit (CU) according to claim 6, wherein the transforming means (16) execute a frequency compression of the audio signals that are to be transformed.

13. An audio/video playback unit (CU) according to claim 6, wherein the transforming means (16) transform two audio channels with frequency mirroring and frequency shifting of an audio channel.

14. A transmitting loudspeaker (FL, FR) with signal-receiving means for the reception of audio signals (AFL, AFR) and modulated ultrasonic signals (URLR) and with radiating means for radiating the audio signals (AFL, AFR) and the ultrasonic signals (URLR).

15. A transmitting loudspeaker (FL, FR) according to claim 14, wherein it is in the form of a passive loudspeaker box and the signal-receiving means for the reception of audio signals (AFL, AFR) and modulated ultrasonic signals (URLR) comprise a frequency-separating filter.

16. A transmitting loudspeaker (FL, FR) according to claim 14, characterized in that the radiating means comprise an ultrasonic tweeter.

17. A receiving loudspeaker (RL, RR) with receiving means (6, 7) for the reception of modulated ultrasonic signals (URLR) and with demodulating means (8) provided as inverse transforming means for the demodulating of audio signals (ARL, ARR) contained in the ultrasonic signals (URLR) and with reproducing means for the acoustic reproduction of the audio signals (ARL, ARR).

18. A receiving loudspeaker (RL, RR) according to claim 17, wherein the demodulating means (8) communicate with a selector switch (13) for selecting one of several audio channels contained in the modulated ultrasonic signal (URLR).

19. A receiving loudspeaker (RL, RR) according to claim 17, wherein the demodulating means (8) comprise a digital signal processor.

20. A receiving loudspeaker (RL, RR) according to claim 14, wherein the receiving means (6, 7) comprise a microphone (6) and a microphone amplifier (7), and preferably the amplification of the microphone amplifier (7) can be controlled by the demodulating means (8).
